(19) United States
(12) Patent Application Publication
(10) Pub. No.: US 2018/0083750 A1
(43) Pub. Date: Mar. 22, 2018

(54) Design For Communication Systems Suffering Burst Error

(71) Applicant: MediaTek Inc., Hsinchu City (TW)

(72) Inventors: Xiu-Sheng Li, Taipei City (TW); Wei-Jen Chen, Taipei City (TW); Wei-De Wu, Hsinchu City (TW)

(21) Appl. No.: 15/710,825

(22) Filed: Sep. 20, 2017

Related U.S. Application Data
(60) Provisional application No. 62/397,966, filed on Sep. 22, 2016.

(51) Int. Cl. H04L 5/00; H04W 72/08

(52) U.S. Cl. CPC H04L 5/0041; H04W 72/082

(57) ABSTRACT

Concepts and examples pertaining to improved design for communication systems suffering burst error are described. A processor of a user equipment (UE) receives data over a data channel. The processor also receives an indication that at least a portion of the data channel is subject to interference from one or more interfering signals. The processor either de-weights one or more affected resource elements in the data according to the indication to mitigate impact by the interference or processes the data without considering the indication

### CROSS REFERENCE TO RELATED PATENT APPLICATION(S)

The present disclosure claims the priority benefit of U.S. Provisional Patent Application No. 62/397,966, filed 22 Sep. 2016, the content of which is incorporated by reference in its entirety.

### TECHNICAL FIELD

The present disclosure is generally related to communication systems and, more particularly, to improved design for communication systems suffering burst error.

### BACKGROUND

Unless otherwise indicated herein, approaches described in this section are not prior art to the claims listed below and are not admitted as prior art by inclusion in this section.

In telecommunication, a burst error or error burst refers to a contiguous sequence of symbols received over a data transmission channel where first and last symbols in the sequence are in error with no contiguous sequence of correctly received symbols of a certain size within the error burst. For example, when there are multiple codeblocks (CBs) in one transmission of a transport block (TB), one or more of the CBs may contain error. The burst error may be due to burst noise.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to provide solutions, schemes, concepts, mechanisms, methods and systems to improve system capacity for communication systems suffering burst error.

In one aspect, a method may involve a processor of a UE receiving data over a data channel. The method may also involve the processor receiving an indication that at least a portion of the data channel is subject to interference from one or more interfering signals. The method may further involve the processor processing the data.

In one aspect, a method may involve a processor of a UE receiving data from a network node of a mobile communication network. The method may also involve the processor transmitting a feedback to the network node regarding the received data. The data may be received in at least one TB comprising a plurality of CBs. The feedback may include a TB-level feedback or a CB-level feedback of acknowledgement (ACK) or negative acknowledgement (NACK).

In one aspect, a method may involve a processor of a UE receive data from a network node of a mobile communication network. The method may also involve the processor determining that there is a need for retransmission of the data. The method may further involve the processor signaling the need for the retransmission of the data along with a suggestion of one or more parameters related to the retransmission.

In one aspect, a method may involve a processor of a UE receiving first data from a network node of a mobile communication network. The method may also involve the processor determining that there is a need for retransmission of the first data. The method may also involve the processor signaling to the network node the need for the retransmission of the first data. The method may also involve the processor receiving from the network node second data along with a retransmission of at least a portion of the first data.

It is noteworthy that, although description provided herein may be in the context of certain radio access technologies, networks and network topologies such as LTE, LTE-Advanced, LTE-Advanced Pro, 5^{th} Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme corresponding to a solution in accordance with the present disclosure.

FIG. 2 is a diagram of an example scheme corresponding to a solution in accordance with the present disclosure.

FIG. 3 is a diagram of an example scheme corresponding to a solution in accordance with the present disclosure.

FIG. 4 is a diagram of an example scheme corresponding to a solution in accordance with the present disclosure.

FIG. 5 is a block diagram of an example system in accordance with an implementation of the present disclosure.

FIG. 6 is a flowchart of an example process in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

In general, there are two scenarios of burst error. In the first scenario, one TB may be composed of one or more CBs and at least one of the CBs is interfered by bursty noise. In the second scenario, one TB may be composed of multiple CBs and some of the CBs are not decodable. For instance, the CBs that are not decodable may be interfered by bursty noise or due to some other reason. For each of the two scenarios, the present disclosure provides solutions, schemes, concepts, mechanisms, methods and systems to improve system capacity for communication systems suffering burst error.

With respect to the first scenario, in which a TB is composed of one or more CBs some of which are interfered by bursty noise, the present disclosure proposes two solutions. Under a first solution for the first scenario, a control channel may be utilized to backward indicate the interfered resource for a user equipment (UE) modem to de-weight the interfered resource, as a noise estimator of the UE modem may not be able to handle this. Under a second solution for the second scenario, control information of bursty noise, if applicable, may be monitored.

With respect to the second scenario, in which a TB is composed of multiple CBs some of which are not decodable, the present disclosure proposes three solutions. Under a first solution for the second scenario, a scheme using CB-level hybrid automatic repeat request (HARQ) may be utilized. Under a second solution for the second scenario, parity bits for HARQ-incremental redundancy (HARQ-IR) and HARQ with erasure codes (HARQ-Erasure) may be jointly utilized. Under a third solution for the second scenario, new data and partial retransmission of previously-transmitted data (old data) may be transmitted together. In addition, with appropriate coding, successful decoding of the old data may also aid in receiving or decoding of the new data. Moreover, the first solution and the second solution for the second scenario may be combined with the third solution for the second scenario.

The various solutions for the first scenario and the second scenario of burst error are described below.

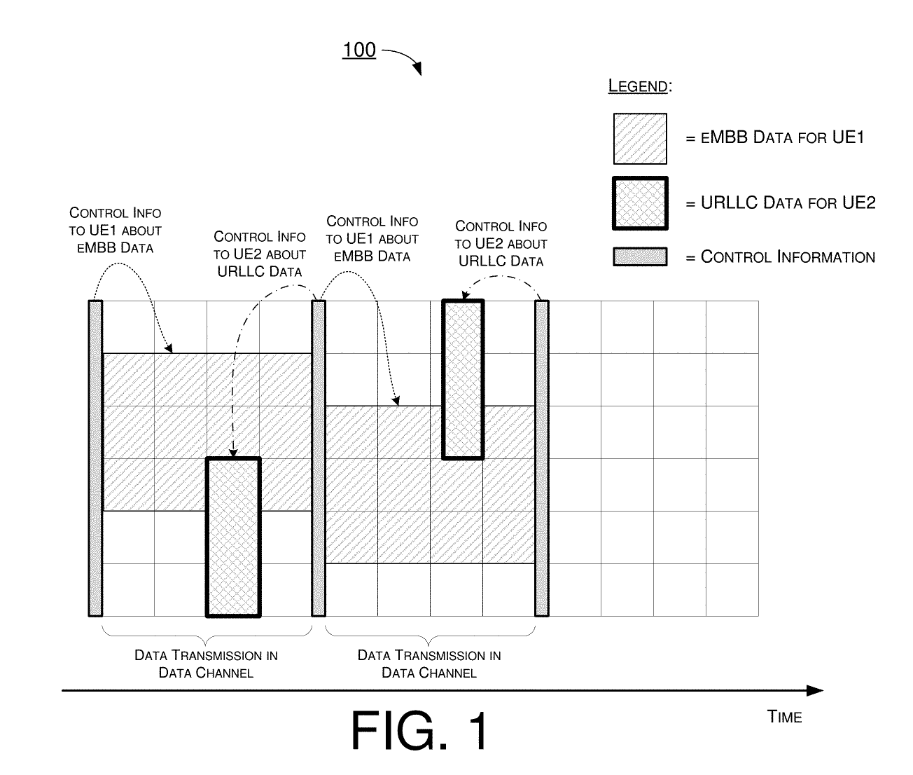

FIG. 1 illustrates an example scheme 100 corresponding to the first solution for the first scenario of burst error in accordance with the present disclosure. Under scheme 100, backward indication may be provided by a base station (e.g., eNB, gNB or transmission-and-receiving point (TRP)) to a UE that at least a portion of a data channel may be subject to interference from one or more interfering signals. For instance, the indication may also indicate that the interference punctures the data or that the interference is superposed on the data.

Under scheme 100, the indication may be provided over a control channel, the data channel in which the data is transmitted, or a different (new) physical channel. Moreover, the indication may be provided during the same duration of the data channel in which interfered or otherwise impacted data is transmitted from the base station to the UE or during a subsequent duration. The indication may be provided via a common signaling for a plurality of UEs including the UE, a UE-specific signaling specifically for the UE, or a group-common signaling for a subset of the plurality of UEs including the UE.

Under scheme 100, in processing the interfered or otherwise impacted data, the UE may de-weight one or more affected resource elements in the data according to the indication, thereby mitigating impact by the interference and improving decoding performance. Alternatively, the UE may process the data without considering the indication.

Under scheme 100, the UE may be capable of setting a level of granularity of regions of the data, and the indication may be a high-layer signaling from the base station to the UE indicating one or more regions of the data subject to the interference. For instance, the data may be received in at least one transport block (TB), and each of the at least one TB may include one or more codeblocks (CBs). Thus, the level of granularity may be CB-level granularity in case that pre-emption indication is UE-specific. Moreover, in case of common indication, the level of granularity may be one OFDM symbol, half OFDM symbol, or even smaller.

For illustrative purposes and without limitation, in the example shown in FIG. 1, a first UE (UE1) may be receiving Enhanced Mobile Broadband (eMBB) data from a base station while a second UE (UE2) may be receiving Ultra-Reliable Low-Latency Communications (URLLC) data from the base station. As URLLC data to UE2 may have a higher priority than eMBB data to UE1, in each data channel in which the eMBB data is transmitted to UE1 the URLLC data is also transmitted to UE2 by the base station. As a result, the URLLC data may puncture the eMBB data or may be superposed on the eMBB data. As part of backward indication in accordance with the present disclosure, the base station may inform UE1 about the interference either during the same duration in which the interference occurs or in the immediately subsequent duration in which subsequent data is transmitted to UE1. The indication may be granular (e.g., CB-level or OFDM symbol-level granularity) in terms of the whereabouts of the interference. Upon receiving such indication from the base station, UE1 may de-weight the interfered CB(s) or RE(s) to mitigate the impact and improve decoding performance.

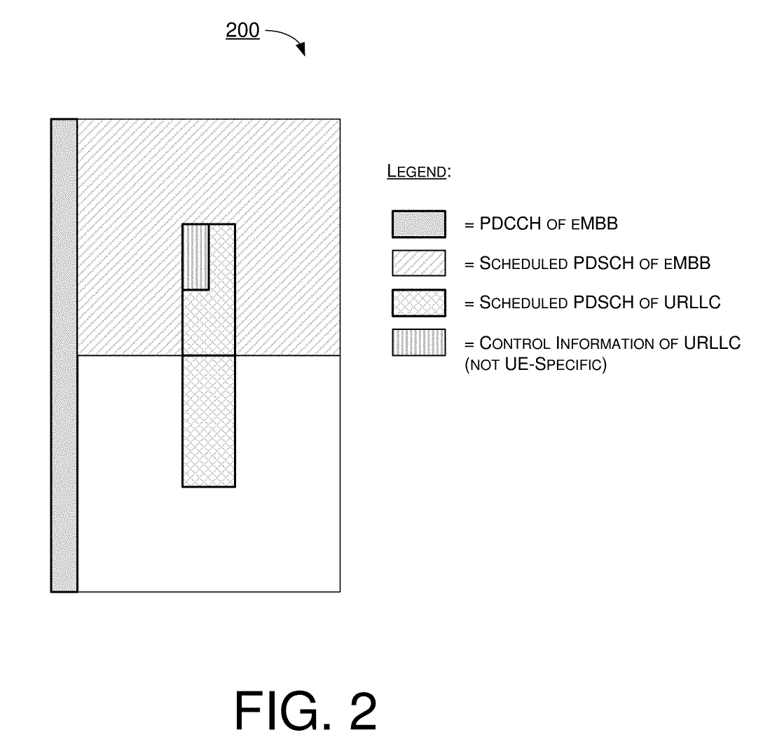

FIG. 2 illustrates an example scheme 200 corresponding to the second solution for the first scenario of burst error in accordance with the present disclosure. Under scheme 200, a UE may monitor control information as a proactive way to learn about possible interference. For instance, a UE receiving data of a lower priority (e.g., eMBB data) may monitor possible control information about data of a higher priority (e.g., URLLC data) to be transmitted by a base station to one or more other UEs.

In the example shown in FIG. 2, a UE (e.g., UE1) receiving eMBB data may receive control information in the physical downlink control channel (PDCCH) about the eMBB data to be received. Subsequently, the UE may receive the eMBB data in a scheduled physical downlink shared channel (PDSCH) of eMBB data. The UE may also monitor control information of URLLC data to be transmitted to another UE (e.g., UE2), which may be not UE-specific in this example, during a scheduled PDSCH of URLLC data. In this example, there may be no control information of URLLC data unless there is URLLC data to be transmitted (e.g., to UE2).

Under a scheme (not shown) corresponding to the first solution for the second scenario of burst error in accordance with the present disclosure, a UE suffering burst error may provide feedback to a base station at the expense of extra uplink overhead. This may be achieved by one of a number of approaches described below. Moreover, as the data may be received by the UE in at least one TB, which may include multiple CBs, the UE may partition the CBs into two or more CB groups with one or more CBs in each CB group. Thus, the feedback may include a TB-level feedback or a CB-level feedback of acknowledgement (ACK) or negative acknowledgement (NACK). The UE may receive retransmission of data containing one or more CB groups each associated with a NACK feedback. The UE may receive the retransmission alone (without any other data) or the UE may receive the retransmission with corresponding one or more of other CB groups received during a previous transmission from the base station.

In a first approach under this scheme, for two defined CB groups, the feedback may be in one of four possible states as {(ACK, ACK), (ACK, NACK), (NACK, ACK), (NACK, NACK)}. The ACK indicates data received with no error for the corresponding CB group, and the NACK indicates data received with error for the corresponding CB group. Upon receiving the feedback from the UE, the base station may retransmit the CB group associated with a NACK in the feedback.

In a second approach under this scheme, the feedback may include a CB-level feedback. Specifically, the feedback may indicate a starting CB index and an ending CB index to identify one or more CBs that are in error. For instance, the feedback may indicate {ACK, starting CB index of erroneous CB (CB_Istart) and ending CB index of erroneous CB (CB_lend)}. Accordingly, the base station may retransmit those CBs between CB_Istart and CB_lend.

In a third approach under this scheme, the feedback may include a CB-level feedback. Specifically, the feedback may indicate a number of undecodable CBs. For instance, the feedback may indicate {ACK, number of undecodable CBs}. Accordingly, the base station may retransmit more bits or less bits depending on the number of undecodable CBs indicated in the feedback.

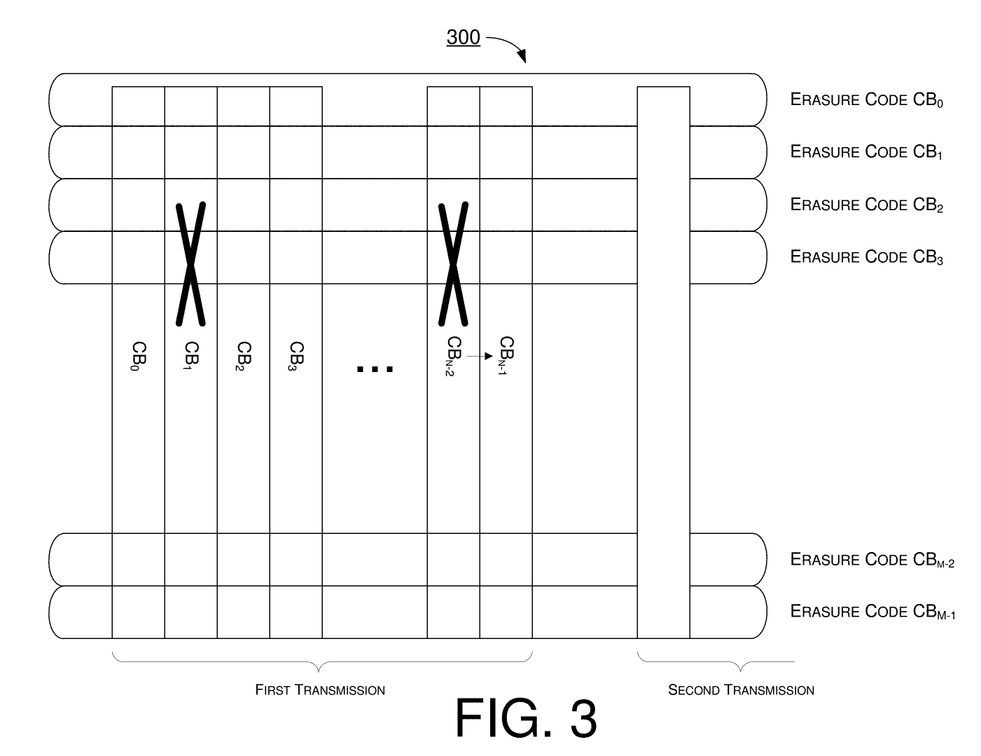

FIG. 3 illustrates an example scheme 300 corresponding to the second solution for the second scenario of burst error in accordance with the present disclosure. Under scheme 300, based on decoding results, the UE may suggest one or more parameters related to retransmission to the base station. For example, the UE may suggest a set of original encoded bits for incremental redundancy (IR) for HARQ (HARQ-IR) in cases where there are relatively more undecodable CBs. As another example, the UE may suggest additional erasure code(s) for HARQ with erasure codes (HARQ-Erasure) in cases where there are relatively fewer undecodable CBs. The feedback from the UE may include ACK, NACK-IR1, NACK-IR2, and so on. That is, with HARQ-IR1˜HARQ-IRX (with X denoting the index of retransmission version), different portion(s) of retransmission may be performed. In other words, the UE may suggest the retransmission version (RV) (e.g., from a predefined set of RVs) to the base station. Alternatively, the feedback from the UE may include ACK, NACK-Erasure1, NACK-Erasure2, and so on. With HARQ-Erasure1˜HARQ-ErasureX (with X denoting the index of code rate), different retransmission corresponding to different code rates may be performed. In this example, different code rates may be defined for erasure codes. Thus, HARQ-Erasure1 may be used to suggest the base station (e.g., gNB) to retransmit with code rate index number 1, and HARQ-ErasureX may be used to suggest the base station to retransmit with code rate index number X. In any case, the base station may retransmit the transport block having the erroneous CBs based on NACK-IR or NACK-Erasure. The base station may signal its parity type by PDCCH. Moreover, the base station may strictly follow the UE's feedback with no signaling required by PDCCH.

For illustrative purposes and without limitation, in the example shown in FIG. 3, among the N CBs transmitted during a first transmission (codeblocks CB₀˜CB_{N-1}) CB₁ and CB_{N-2} are not decodable. In case of HARQ-IR, there may be unnecessarily excessive number of bits or amount of data to be retransmitted to recover CB₁ and CB_{N-2}. However, with additional erasure codes (e.g., erasure code CB₀˜erasure code CB_{M-1}), the number of bits or amount of data to be retransmitted during a second transmission may be less to a significant extent compared to that with HARQ-IR.

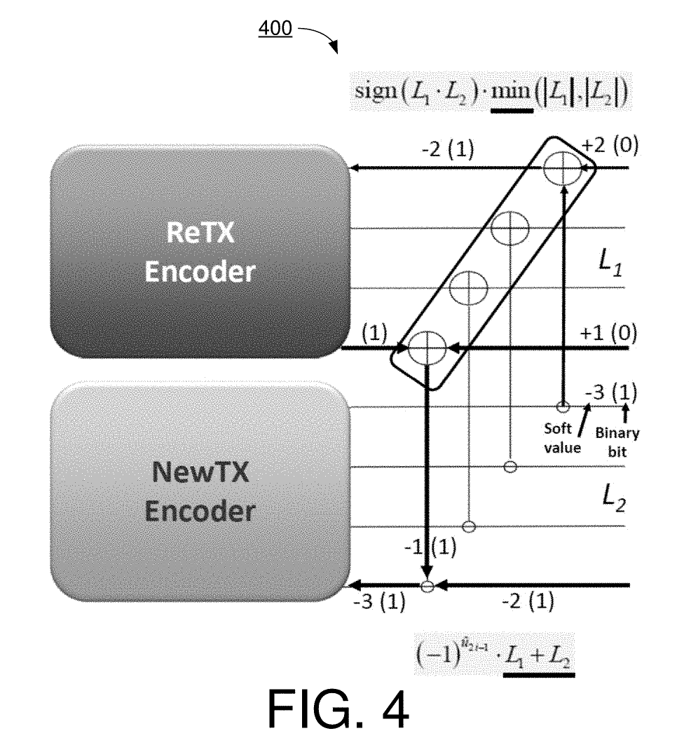

FIG. 4 illustrates an example scheme 400 corresponding to the third solution for the second scenario of burst error in accordance with the present disclosure. Under scheme 400, upon determining that there is a need for retransmission of first data after receiving the first data from a base station (e.g., the first data contains error or is not decodable), a UE may signal to the base station to indicate the need for retransmission of the first data. In return, under scheme 400, the UE may receive second data (new data) along with the retransmission of at least a portion of the first data. Moreover, the second data may be encoded with the retransmitted portion of the first data.

For illustrative purposes and without limitation, in the example shown in FIG. 4, the base station may employ a retransmission (ReTX) encoder and a new transmission (NewTX) encoder such that ReTX helps NewTX. For instance, as shown in the upper portion of FIG. 4, the ReTX may be interfered and, as shown in the lower portion of FIG. 4, the NewTX may be enhanced if an ACK is received from the UE for the ReTX. Specifically, received ReTX data may contribute to diversity of NewTX. Moreover, ReTX may be easier to acknowledge by combining the log-likelihood-ratios (LLRs) of the first transmission.

### Illustrative Implementation

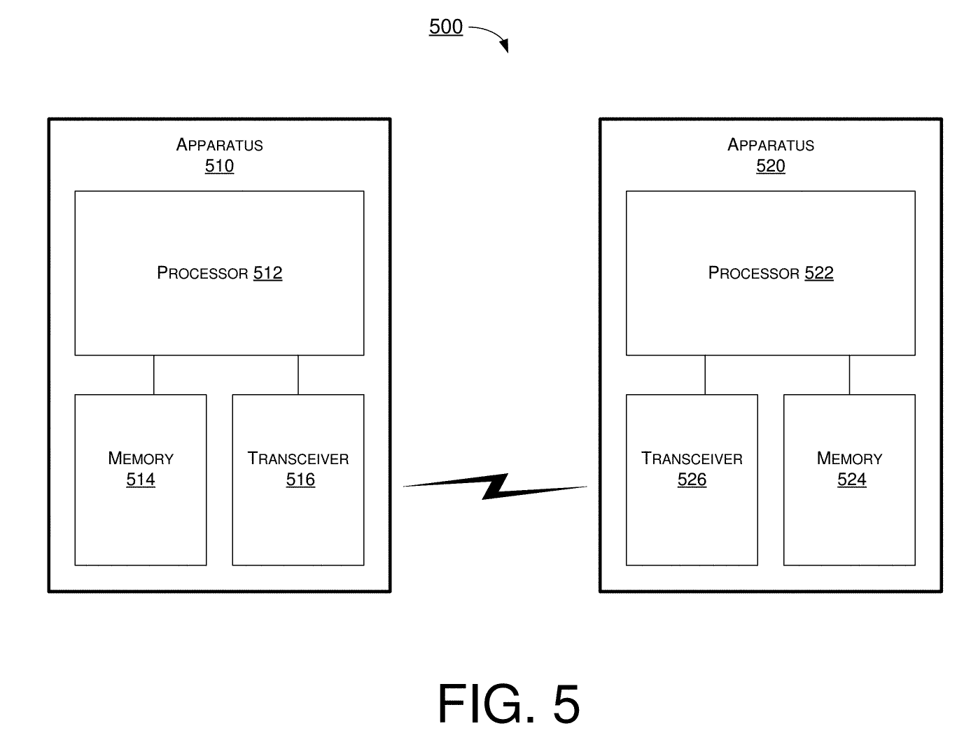

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to improved design for communication systems suffering burst error, including the various solutions, schemes, concepts and examples described above with respect to FIG. 1˜FIG. 4 described above as well as processes 600, 700, 800 and 900 described below.

Each of apparatus 510 and apparatus 520 may be a part of an electronic apparatus, which may be a base station (BS) or a user equipment (UE), such as a portable or mobile apparatus, a wearable apparatus, a wireless communication apparatus or a computing apparatus. For instance, each of apparatus 510 and apparatus 520 may be implemented in a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a BS, apparatus 510 and/or apparatus 520 may be implemented in an eNodeB in a LTE, LTE-Advanced or LTE-Advanced Pro network or in a gNB or transmit-and-receive point (TRP) in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1˜FIG. 4, each of apparatus 510 and apparatus 520 may be implemented in or as a BS or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to improved design for communication systems suffering burst error in accordance with various implementations of the present disclosure.

In some implementations, apparatus 510 may also include a transceiver 516 coupled to processor 512. Transceiver 516 may be capable of wirelessly transmitting and receiving data, information and/or signals. In some implementations, apparatus 520 may also include a transceiver 526 coupled to processor 522. Transceiver 526 may include a transceiver capable of wirelessly transmitting and receiving data, information and/or signals.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

In the interest of brevity and to avoid redundancy, detailed description of functions, capabilities and operations of apparatus 510 and apparatus 520 is provided below with respect to processes 600, 700, 800 and 900.

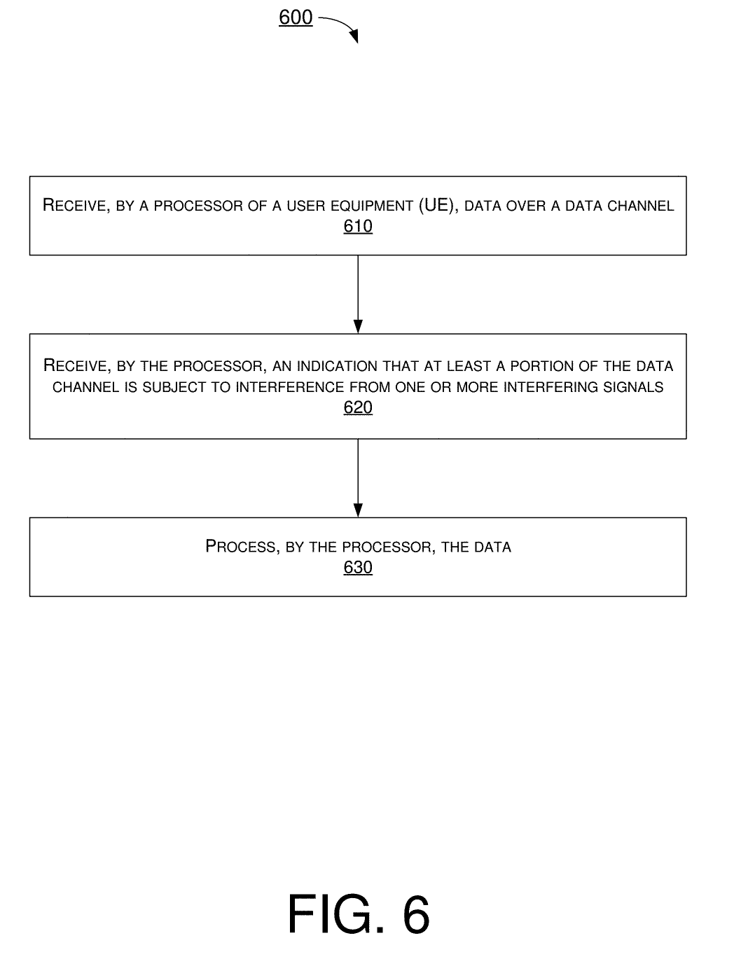

FIG. 6 illustrates an example process 600 in accordance with an implementation of the present disclosure. Process 600 may represent an aspect of implementing the proposed concepts and schemes such as one or more of the various solutions, schemes, concepts and examples described above with respect to FIG. 1˜FIG. 4. More specifically, process 600 may represent an aspect of the proposed concepts and schemes pertaining to improved design for communication systems suffering burst error. For instance, process 600 may be an example implementation, whether partially or completely, of the proposed schemes, concepts and examples described above for improved design for communication systems suffering burst error. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively in a different order. The blocks/sub-blocks of process 600 may be executed iteratively. Process 600 may be implemented by or in apparatus 510 and/or apparatus 520 as well as any variations thereof. Solely for illustrative purposes and without limiting the scope, process 600 is described below in the context of apparatus 510 being a UE and apparatus 520 being a network node (e.g., a base station) of a mobile communication network (e.g., an NR network). Process 600 may begin at block 610.

At 610, process 600 may involve processor 512 of apparatus 510 as a UE receiving, via transceiver 516 (from apparatus 520 as a network node), data over a data channel. Process 600 may proceed from 610 to 620.

At 620, process 600 may involve processor 512 receiving, via transceiver 516 (from apparatus 520), an indication that at least a portion of the data channel is subject to interference from one or more interfering signals. Process 600 may proceed from 620 to 630.

At 630, process 600 may involve processor 512 processing the received data.

In some implementations, in receiving the indication, process 600 may involve processor 512 receiving the indication over a control channel, the data channel, or a different physical channel.

In some implementations, in receiving the indication, process 600 may involve processor 512 receiving the indication in a first duration during which the data is received or in a second duration after the first duration.

In some implementations, the indication may also indicate that the interference punctures the data or that the interference is superposed on the data.

In some implementations, in processing the data, process 600 may involve processor 512 de-weighting one or more affected resource elements in the data according to the indication to mitigate impact by the interference. Alternatively, process 600 may involve processor 512 processing the data without considering the indication.

In some implementations, in receiving the indication, process 600 may involve processor 512 receiving the indication from a common signaling for a plurality of UEs including apparatus 510, a UE-specific signaling specifically for apparatus 510, or a group-common signaling for a subset of the plurality of UEs including apparatus 510.

In some implementations, processor 512 may be capable of setting a level of granularity of regions of the data. In such case, the indication may include a high-layer signaling indicating one or more regions of the data subject to the interference.

In some implementations, the data may be received in at least one transport block (TB), wherein each of the at least one TB comprises one or more codeblocks (CBs), and wherein the level of granularity is CB-level granularity.

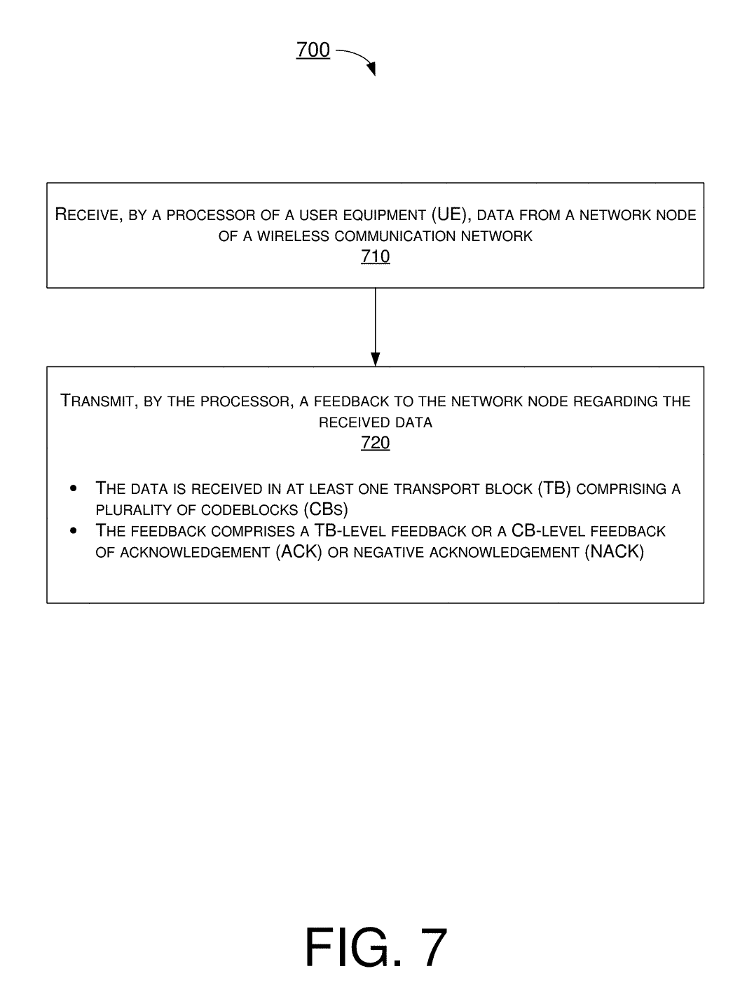

FIG. 7 illustrates an example process 700 in accordance with an implementation of the present disclosure. Process 700 may represent an aspect of implementing the proposed concepts and schemes such as one or more of the various solutions, schemes, concepts and examples described above with respect to FIG. 1˜FIG. 4. More specifically, process 700 may represent an aspect of the proposed concepts and schemes pertaining to improved design for communication systems suffering burst error. For instance, process 700 may be an example implementation, whether partially or completely, of the proposed schemes, concepts and examples described above for improved design for communication systems suffering burst error. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively in a different order. The blocks/sub-blocks of process 700 may be executed iteratively. Process 700 may be implemented by or in apparatus 510 and/or apparatus 520 as well as any variations thereof. Solely for illustrative purposes and without limiting the scope, process 700 is described below in the context of apparatus 510 being a UE and apparatus 520 being a network node (e.g., a base station) of a mobile communication network (e.g., an NR network). Process 700 may begin at block 710.

At 710, process 700 may involve processor 512 of apparatus 510 as a UE receiving, via transceiver 516, data from apparatus 520 as a network node of a mobile communication network. Process 700 may proceed from 710 to 720.

At 720, process 700 may involve processor 512 transmitting, via transceiver 516, a feedback to apparatus 520 regarding the received data. The data may be received in at least one transport block (TB) comprising a plurality of codeblocks (CBs). The feedback may include a TB-level feedback or a CB-level feedback of acknowledgement (ACK) or negative acknowledgement (NACK).

In some implementations, the feedback may include a CB-level feedback. In transmitting the feedback, process 700 may involve processor 512 partitioning the plurality of CBs of the at least one TB into multiple CB groups of CBs. In such case, the feedback may indicate ACK or NACK for each CB group of the multiple CB groups depending on a decoding result of the respective CB group.

In some implementations, process 700 may further involve processor 512 receiving from apparatus 520, via transceiver 516, retransmission of one or more of the CB groups each of which associated with a NACK feedback. In some implementations, in receiving the retransmission, process 700 may involve processor 512 receiving the retransmission alone or receiving the retransmission with corresponding one or more of other CB groups received during a previous transmission from the network node.

In some implementations, the feedback may include a CB-level feedback. In such case, the feedback may indicate a starting CB index and an ending CB index to identify one or more CBs of the plurality of CBs in error. Moreover, process 700 may further involve processor 512 receiving from apparatus 520, via transceiver 516, retransmission of at least one CB among the one or more CBs identified by the starting CB index and the ending CB index.

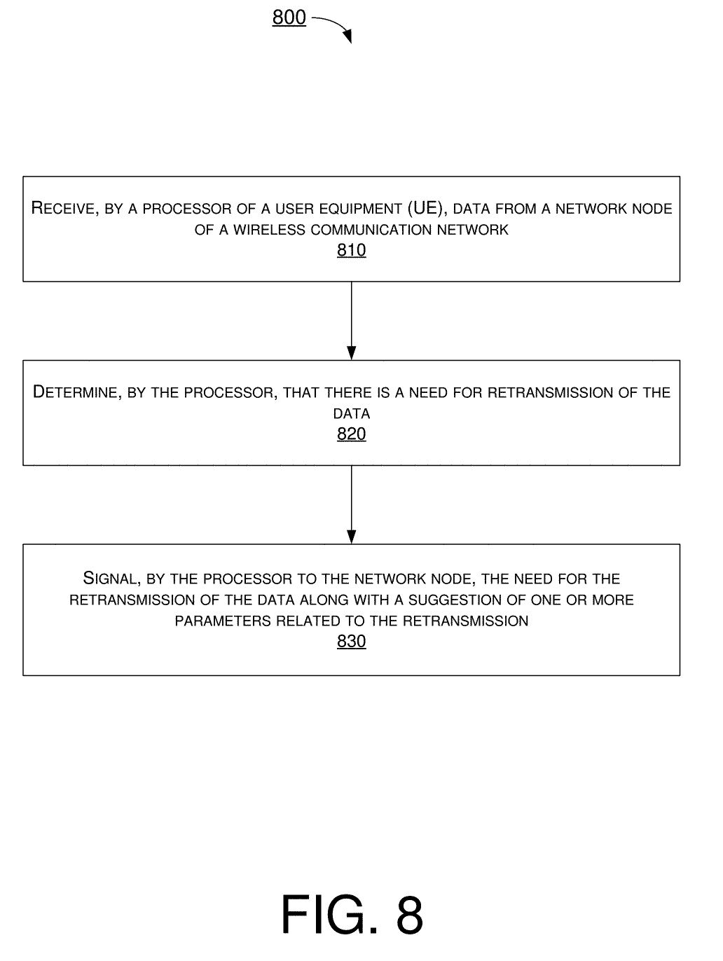

FIG. 8 illustrates an example process 800 in accordance with an implementation of the present disclosure. Process 800 may represent an aspect of implementing the proposed concepts and schemes such as one or more of the various solutions, schemes, concepts and examples described above with respect to FIG. 1˜FIG. 4. More specifically, process 800 may represent an aspect of the proposed concepts and schemes pertaining to improved design for communication systems suffering burst error. For instance, process 800 may be an example implementation, whether partially or completely, of the proposed schemes, concepts and examples described above for improved design for communication systems suffering burst error. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively in a different order. The blocks/sub-blocks of process 800 may be executed iteratively. Process 800 may be implemented by or in apparatus 510 and/or apparatus 520 as well as any variations thereof. Solely for illustrative purposes and without limiting the scope, process 800 is described below in the context of apparatus 510 being a UE and apparatus 520 being a network node (e.g., a base station) of a mobile communication network (e.g., an NR network). Process 800 may begin at block 810.

At 810, process 800 may involve processor 512 of apparatus 510 as a UE receiving, via transceiver 516, data from apparatus 520 as a network node of a mobile communication network. Process 800 may proceed from 810 to 820.

At 820, process 800 may involve processor 512 determining that there is a need for retransmission of the data (e.g., the data contains error or is not decodable). Process 800 may proceed from 820 to 830.

At 830, process 800 may involve processor 512 signaling to apparatus 520, via transceiver 516, the need for the retransmission of the data along with a suggestion of one or more parameters related to the retransmission.

In some implementations, the suggestion may include a suggestion for incremental redundancy (IR) for hybrid automatic repeat request (HARQ) or HARQ with erasure codes.

In some implementations, in signaling the need for the retransmission of the data along with the suggestion of one or more parameters related to the retransmission, process 800 may involve processor 512 selecting a redundancy version (RV) from a predefined set of RVs. Additionally, process 800 may involve processor 512 signaling, via transceiver 516, the RV to apparatus 520.

In some implementations, the suggestion may include a suggestion for retransmission of one or more CBs of the data that are encoded by erasure codes.

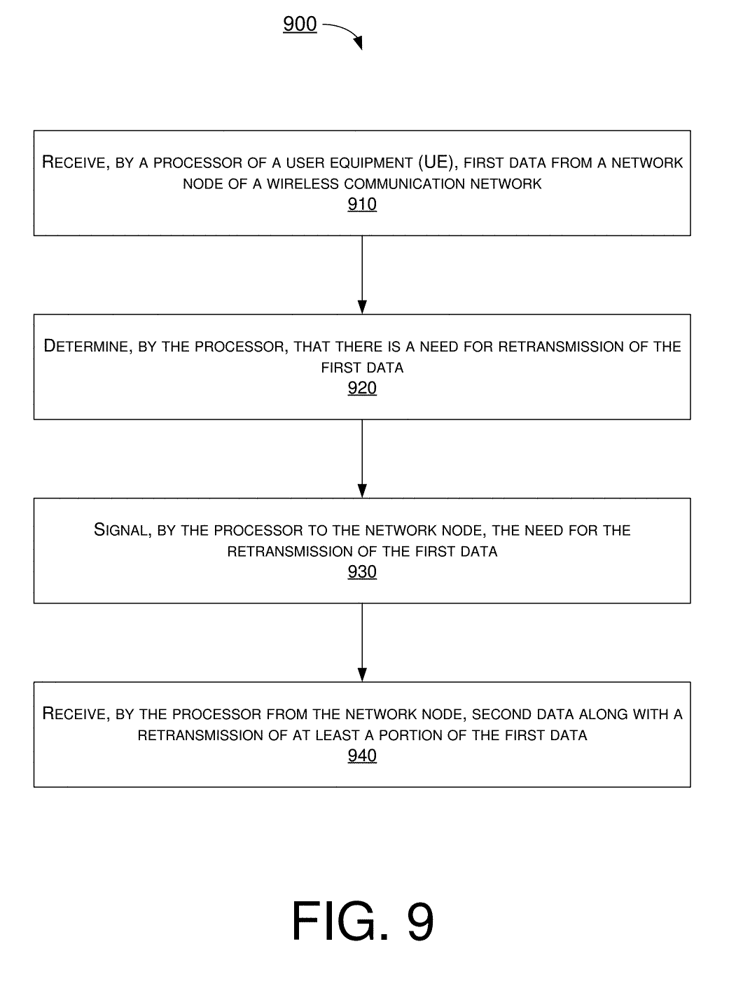

FIG. 9 illustrates an example process 900 in accordance with an implementation of the present disclosure. Process 900 may represent an aspect of implementing the proposed concepts and schemes such as one or more of the various solutions, schemes, concepts and examples described above with respect to FIG. 1˜FIG. 4. More specifically, process 900 may represent an aspect of the proposed concepts and schemes pertaining to improved design for communication systems suffering burst error. For instance, process 900 may be an example implementation, whether partially or completely, of the proposed schemes, concepts and examples described above for improved design for communication systems suffering burst error. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively in a different order. The blocks/sub-blocks of process 900 may be executed iteratively. Process 900 may be implemented by or in apparatus 510 and/or apparatus 520 as well as any variations thereof. Solely for illustrative purposes and without limiting the scope, process 900 is described below in the context of apparatus 510 being a UE and apparatus 520 being a network node (e.g., a base station) of a mobile communication network (e.g., an NR network). Process 900 may begin at block 910.

At 910, process 900 may involve processor 512 of apparatus 510 as a UE receiving, via transceiver 516, first data from apparatus 520 as a network node of a mobile communication network. Process 900 may proceed from 910 to 920.

At 920, process 900 may involve processor 512 determining that there is a need for retransmission of the first data (e.g., the first data contains error or is not decodable). Process 900 may proceed from 920 to 930.

At 930, process 900 may involve processor 512 signaling to apparatus 520, via transceiver 516, the need for the retransmission of the first data. Process 900 may proceed from 930 to 940.

At 940, process 900 may involve processor 512 receiving from apparatus 520, via transceiver 516, second data along with a retransmission of at least a portion of the first data.

In some implementations, the second data may be encoded with the at least a portion of the first data in the retransmission. That is, the second data and the retransmitted portion of the first data may be encoded together.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), data over a data channel;
receiving, by the processor, an indication that at least a portion of the data channel is subject to interference from one or more interfering signals; and
processing, by the processor, the data.

2. The method of claim 1, wherein the receiving of the indication comprises receiving the indication over a control channel, the data channel, or a different physical channel.

3. The method of claim 1, wherein the receiving of the indication comprises receiving the indication in a first duration during which the data is received or in a second duration after the first duration.

4. The method of claim 1, wherein the indication further indicates that the interference punctures the data or that the interference is superposed on the data.

5. The method of claim 1, wherein the processing of the data comprises de-weighting one or more affected resource elements in the data according to the indication to mitigate impact by the interference or processing the data without considering the indication.

6. The method of claim 1, wherein the receiving of the indication comprises receiving the indication from a common signaling for a plurality of UEs including the UE, a UE-specific signaling specifically for the UE, or a group-common signaling for a subset of the plurality of UEs including the UE.

7. The method of claim 1, wherein the processor is capable of setting a level of granularity of regions of the data, and wherein the indication comprises a high-layer signaling indicating one or more regions of the data subject to the interference.

8. The method of claim 7, wherein the level of granularity is one OFDM symbol, half OFDM symbol, or smaller.

9. A method, comprising:
receiving, by a processor of a user equipment (UE), data from a network node of a mobile communication network; and
transmitting, by the processor, a feedback to the network node regarding the received data,
wherein the data is received in at least one transport block (TB) comprising a plurality of codeblocks (CBs), and
wherein the feedback comprises a TB-level feedback or a CB-level feedback of acknowledgement (ACK) or negative acknowledgement (NACK).

10. The method of claim 9, wherein the feedback comprises a CB-level feedback, wherein the transmitting of the feedback comprises partitioning the plurality of CBs of the at least one TB into multiple CB groups of CBs, and wherein the feedback indicates ACK or NACK for each CB group of the multiple CB groups depending on a decoding result of the respective CB group.

11. The method of claim 10, further comprising:
receiving, by the processor from the network node, retransmission of one or more of the CB groups each of which associated with a NACK feedback.

12. The method of claim 11, wherein the receiving of the retransmission comprises receiving the retransmission alone or receiving the retransmission with corresponding one or more of other CB groups received during a previous transmission from the network node.

13. The method of claim 9, wherein the feedback comprises a CB-level feedback, and wherein the feedback indicates a starting CB index and an ending CB index to identify one or more CBs of the plurality of CBs in error.

14. The method of claim 13, further comprising:
receiving, by the processor from the network node, retransmission of at least one CB among the one or more CBs identified by the starting CB index and the ending CB index.

15. A method, comprising:
receiving, by a processor of a user equipment (UE), data from a network node of a mobile communication network;
determining, by the processor, that there is a need for retransmission of the data; and
signaling, by the processor to the network node, the need for the retransmission of the data along with a suggestion of one or more parameters related to the retransmission.

16. The method of claim 15, wherein the suggestion comprises a suggestion for incremental redundancy (IR) for hybrid automatic repeat request (HARQ) or HARQ with erasure codes.

17. The method of claim 15, wherein the signaling of the need for the retransmission of the data along with the suggestion of one or more parameters related to the retransmission comprises:
selecting a redundancy version (RV) from a predefined set of RVs; and
signaling the RV to the network node.

18. The method of claim 15, wherein the suggestion comprises a suggestion for retransmission of one or more codeblocks (CBs) of the data that are encoded by erasure codes.

19. A method, comprising:
receiving, by a processor of a user equipment (UE), first data from a network node of a mobile communication network;
determining, by the processor, that there is a need for retransmission of the first data;
signaling, by the processor to the network node, the need for the retransmission of the first data; and
receiving, by the processor from the network node, second data along with a retransmission of at least a portion of the first data.

20. The method of claim 19, wherein the second data is encoded with the at least a portion of the first data in the retransmission.
